(19) United States
(12) Patent Application Publication
(10) Pub. No.: US 2007/0231686 A1
(43) Pub. Date: Oct. 4, 2007

(54) Secondary battery

(76) Inventor: Gil-Ho Kim, Yongin-si (KR)

Correspondence Address: Robert E. Bushnell;Suite 300, 1522 K Street, N.W., Washington, DC, 20005-1202, US

(21) Appl. No.: 11/698,930

(22) Filed: Jan. 29, 2007

(30) Foreign Application Priority Data
Mar. 28, 2006 (KR) 10-2006-0027959

(51) Int. Cl. H01M 2/06; H01M 2/08

(52) U.S. Cl. 429/180; 429/181; 429/174

(57) ABSTRACT

A secondary battery in which the structure of an insulating case arranged between an electrode assembly and a cap assembly prevents electrode tabs from being bent. The secondary battery includes: an electrode assembly including a positive electrode, a negative electrode, a separator interposed between the positive electrode and the negative electrode, and electrode tabs respectively extending from the positive electrode and the negative electrode; a can for accommodating the electrode assembly; a cap assembly attached to an opening of the can and connected to the electrode tabs; and an insulating case arranged between the electrode assembly and the cap assembly and including a hole through which one of the electrode tabs pass, the insulating case including barrier ribs respectively extending from at least portions of side walls of the hole.

### CLAIM OF PRIORITY

This application makes reference to, incorporates the same herein, and claims all benefits accruing under 35 U.S.C.§119 from an application earlier filed in the Korean Intellectual Property Office on 28 Mar. 2006 and there duly assigned Serial No. 10-2006-0027959.

### BACKGROUND OF THE INVENTION

1. Field of the Invention

The present invention relates to a secondary battery, and more particularly, to a secondary battery in which the structure of an insulating case inserted between an electrode assembly and a cap assembly prevents electrode tabs from being bent.

2. Description of the Prior Art

Secondary batteries have been recently researched and developed since secondary batteries can be recharged, are small, and have a high capacity. Representative secondary batteries that have been recently developed and used are nickel-Metal hydride (Ni-MH) batteries, lithium (Li) batteries, and lithium ion (Li-ion) batteries.

In these secondary batteries, an electrode assembly composed of a positive electrode, a negative electrode, and a separator is accommodated in a can commonly formed of aluminum or an aluminum alloy; the can is completed by a cap assembly; an electrolyte is injected into the can, and the can is sealed. The can can be formed of steel. However, when the can is formed of aluminum or an aluminum alloy, the battery can be made light since the aluminum is light and is not corroded when the battery is used at a high voltage for a long time.

The electrode terminals of the sealed secondary battery cells are electrically connected to the terminals of safety apparatus, such as a Positive Temperature Coefficient (PTC) device, a thermal fuse, or a Protective Circuit Module (PCM). The safety apparatus are connected to the positive electrode and the negative electrode to interrupt the current when the voltage of the battery rapidly increases due to excessive charge and discharge and to thus prevent the battery from being damaged.

The safety apparatus and the bare cells are accommodated in an additional package where the safety apparatus and the bare cells are electrically connected to each other or where spaces between the safety apparatus and the bare cells are filled with a melted resin and the package is coated to form a battery pack.

FIG. 1 is an exploded perspective view of a conventional secondary battery. Referring to FIG. 1, the conventional secondary battery includes a can 211, an electrode assembly 212 accommodated within the can 211, and a cap assembly mechanically attached to the opened top of the can 211 to seal the top of the can 211.

The electrode assembly 212 is formed by winding a thin plate or layer shaped positive electrode 213, a separator 214, and a negative electrode 215. In the positive electrode 213, a positive electrode tab 216 is electrically connected to the region of a positive electrode collector in which a positive electrode active material layer is not formed. In the negative electrode 215, a negative electrode tab 217 is electrically connected to the region of a negative electrode collector in which a negative electrode active material layer is not formed.

The positive electrode 213 and the negative electrode 215 and the positive and negative electrode tabs 216 and 217 can be arranged in reversed polarities. An insulating tape 218 can be wound on the boundaries where the positive and negative electrode tabs 216 and 217 are withdrawn from the electrode assembly 212 in order to prevent the positive and negative electrode tabs 216 and 217 and the positive and negative electrodes 213 and 215 from being shorted.

The conventional can 211 is formed of a rectangular parallelepiped aluminum or aluminum alloy. The electrode assembly 212 is accommodated through the opened top of the can 211 so that the can 211 functions as the container of the electrode assembly 212 and the electrolyte. The can 211 can also function as a terminal.

A planar plate shaped cap plate 110 having the size and shape corresponding to the opened top of the can 211 is provided in the cap assembly. A terminal through hole is formed in the center of the cap plate 110 so that an electrode terminal 130 can pass through. A tube shaped gasket 120 is provided outside the electrode terminal 130 that penetrates the center of the cap plate 110 so that the electrode terminal 130 and the cap plate 110 are electrically insulated from each other. An insulating plate 140 is provided under the cap plate 110 in the center of the cap plate 110 and around the terminal through hole. A terminal plate 150 is provided under the insulating plate 140. An electrode injecting hole 112 is formed on one side of the cap plate 110. A cap (not shown) is provided in the electrolyte injection hole 112 in order to seal the electrolyte injection hole 112 after the electrolyte has been injected.

On the other hand, an insulating case 190 is further provided between the cap assembly and the electrode assembly 212, and more particularly, under the cap assembly and on the electrode assembly 212. A negative electrode tab hole 191 is formed on one side of the insulating case 190 so that the negative electrode tab 217 can pass through from the electrode assembly 212. A positive electrode tab hole 192 is formed at the edge on the other side in the position corresponding to the positive electrode tab 216. An electrolyte through hole 193 may or may not be additionally formed.

The positive electrode tab 216 can be welded to the rear surface of the cap plate 110 through the positive electrode tab hole 192 of the insulating case 190 and the negative electrode tab 217 can be welded to the rear surface of the electrode terminal 130 through the negative electrode tab hole 191 so that the positive electrode tab 216 and the negative electrode tab 217 are withdrawn from the positive and negative electrodes 213 and 215 of the electrode assembly 212 to be connected to the cap plate 110 and the electrode terminal 130.

FIG. 2 is a side sectional view taken along the line A-A of FIG. 1 of the insulating case and the electrode assembly that are attached to each other. As illustrated in FIG. 2, the insulating case 190 is provided between the cap assembly and the electrode assembly 212 that are illustrated in FIG. 1 to electrically insulate the cap assembly and the electrode assembly 212 from each other. The insulating case 190 is formed of an insulating polymer resin and is preferably formed of polypropylene.

On the other hand, since the negative electrode tab 217 withdrawn from the electrode assembly 212 to pass through the negative electrode tab hole 191 is connected to the electrode terminal 130 illustrated in FIG. 1 in a short distance, the negative electrode tab 217 is folded in zigzags between the insulating case 190 and the cap assembly.

When an external mechanical shock, such as falling or vibration, is applied to the secondary battery having the negative electrode tab folded in zigzags between the cap assembly and the insulating case as described above, the negative electrode tab folded in zigzags can be pushed downward and pressed by the insulating case. In this case, the pressed negative electrode tab is connected to the electrode assembly under the insulating case through the negative electrode tab hole having a predetermined gap so that the positive and negative electrodes can be shorted. Therefore, the stability of the secondary battery deteriorates.

### SUMMARY OF THE INVENTION

Accordingly, the present invention has been made to solve the above-mentioned problems occurring in the prior art, and an object of the present invention is to provide a secondary battery in which the structure of an insulating case inserted between an electrode assembly and a cap assembly prevent electrode tabs from being bent.

In order to accomplish the object of the present invention, a secondary battery is provided including: an electrode assembly including a positive electrode, a negative electrode, a separator interposed between the positive electrode and the negative electrode, and electrode tabs respectively extending from the positive electrode and the negative electrode; a can for accommodating the electrode assembly; a cap assembly attached to an opening of the can and connected to the electrode tabs; and an insulating case arranged between the electrode assembly and the cap assembly and including a hole through which one of the electrode tabs passes, the insulating case including barrier ribs respectively extending from at least portions of side walls of the hole.

At least portions of side walls of the hole are preferably an internal side wall of the hole running parallel to a lengthwise direction of the insulating case.

The electrode tab that passes through the hole is preferably folded in zigzags between the cap assembly and the insulating case and electrically connects an electrode terminal of the cap assembly to one electrode of the electrode assembly.

The barrier ribs are preferably inclined upward away from the insulating case. The barrier ribs preferably run parallel to a front surface of the insulating case. The barrier ribs preferably include tapered ribs whose thickness is reduced toward a center of the hole from the respective hole side wall.

The starting points of the tapered ribs positioned in ends extending from the respective hole side wall are preferably thicker than the barrier ribs.

The barrier ribs are preferably of a thickness in a range of 0.1 to 0.2 mm. The barrier ribs are integral with the insulating case and are of the same material.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a conventional secondary battery;

FIG. 2 is a side sectional view taken along the line A-A of an insulating case and an electrode assembly that are attached to each other;

FIG. 3 is an exploded perspective view of a secondary battery according to an embodiment of the present invention;

FIG. 4 is a perspective view of an enlarged ‘P’ part in the secondary battery of FIG. 3;

FIG. 5 is a side sectional view of barrier ribs taken along the line C-C of the insulating case of FIG. 4;

FIG. 6 is a side sectional view taken along the line B-B of FIG. 3 of the insulating case and the electrode assembly that are attached to each other;

FIG. 7 is a side sectional view of barrier ribs of an insulating case according to another embodiment of the present invention; and

FIG. 8 is a side sectional view of barrier ribs of an insulating case according to still another embodiment of the present invention.

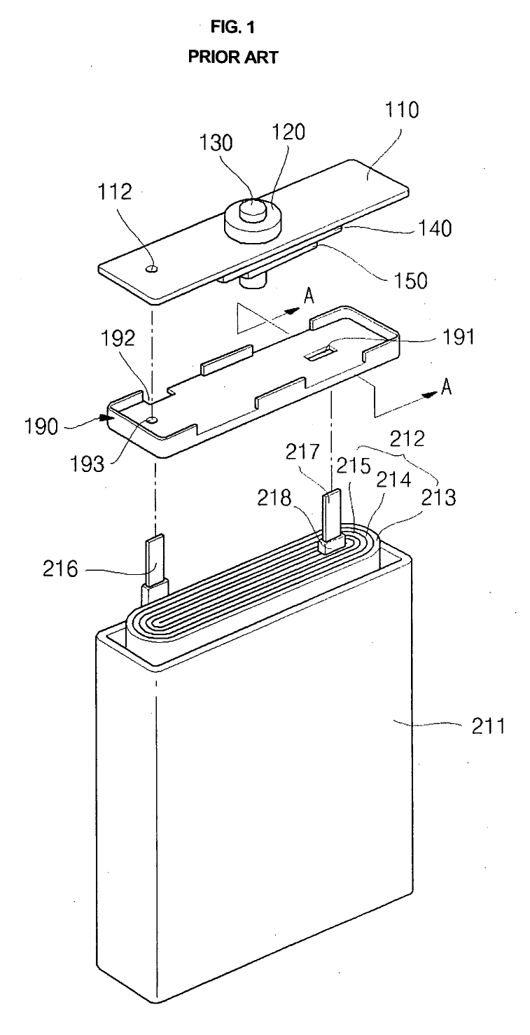

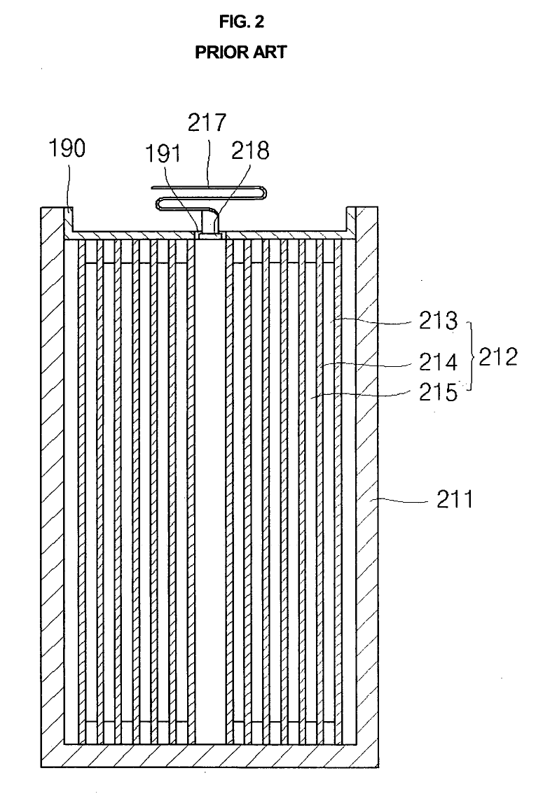

### DETAILED DESCRIPTION OF THE INVENTION

Hereinafter, a secondary battery according to exemplary embodiments of the present invention are described in detail with reference to the accompanying drawings.

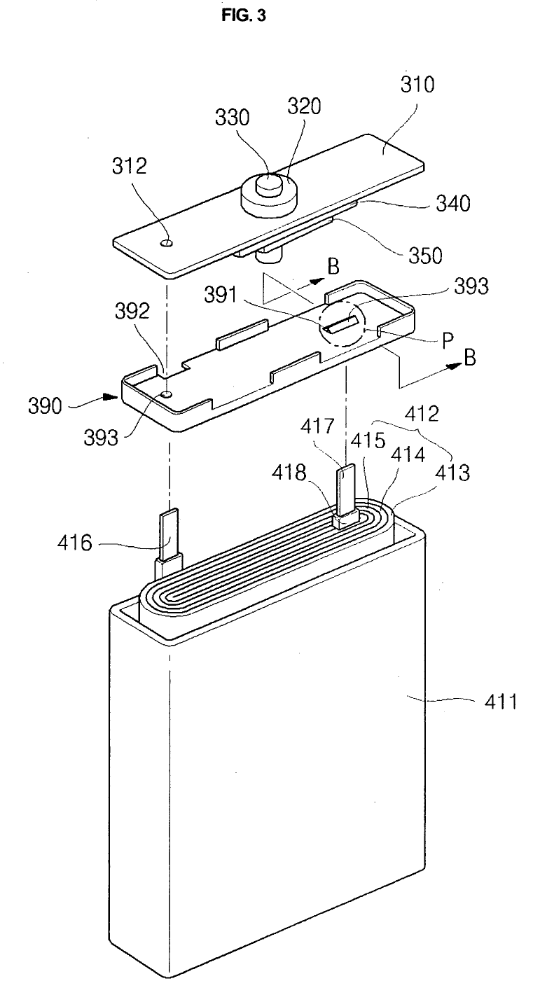

FIG. 3 is an exploded perspective view schematically illustrating a secondary battery according to an embodiment of the present invention. Referring to FIG. 3, the secondary battery according to an embodiment of the present invention includes a can 411, an electrode assembly 412 accommodated within the can 411, and a cap assembly coupled with the opened top of the can 411 to seal up the top of the can 411.

The can 411 can be formed of a rectangular parallelepiped metal and can function as a terminal. According to the present invention, the can 411 functions as a positive terminal. Also, the can 411 can function as a negative terminal according to another embodiment. The electrode assembly 412 is accommodated through the opened top of the can 411.

A positive electrode 413 includes a positive electrode collector formed of a thin metal plate having excellent conductivity, for example, an aluminum foil and a positive electrode active material layer whose main component is a lithium based oxide, coating both surfaces of the foil. A positive electrode tab 416 is electrically connected to the region of the positive electrode collector in which the positive electrode active material layer is not formed on the positive electrode 413.

A negative electrode 415 includes a negative electrode collector formed of a thin metal plate having excellent conductivity, for example, a copper foil and a negative electrode active material layer whose main component is carbon, coating both surfaces of the foil. A negative electrode tab 417 is electrically connected to the region of the negative electrode collector in which the negative electrode active material layer is not formed on the negative electrode 415.

The positive electrode 413 and the negative electrode 415 and the positive and negative electrode tabs 416 and 417 can be arranged in reversed polarities. An insulating tape 418 can be wound on the boundaries where the positive and negative electrode tabs 416 and 417 are withdrawn from the electrode assembly 412 in order to prevent the positive and negative electrode tabs 416 and 417 and the positive and negative electrodes 413 and 415 from being shorted.

A separator 414 is formed of polyethylene, polypropylene, or a co-polymer of the polyethylene and the polypropylene. The separator 414 is preferably formed to be wider than the positive and negative electrodes 413 and 415 in order to prevent the electrode plates from being shorted.

A planar plate shaped cap plate 310 having the size and shape corresponding to the size and shape of the opened top of the can 411 is provided in the cap assembly. A terminal through hole is formed in the center of the cap plate 310 so that an electrode terminal 330 can pass through. A tube shaped gasket 320 is provided outside the electrode terminal 330 that penetrates the center of the cap plate 310 so that the electrode terminal 330 and the cap plate 310 are electrically insulated from each other. An insulating plate 340 is provided under the cap plate 310 in the center of the cap plate 310 and around the terminal through hole. A terminal plate 350 is provided under the insulating plate 340. The cap plate 310 is attached to the can 411 by welding the cap plate 310 to the can 411 to function as the positive terminal like the can 411.

The electrode terminal 330 is inserted through the terminal through hole so that the gasket 320 wraps the outer circumference thereof. The bottom surface of the electrode terminal 330 is electrically connected to the terminal plate 350 where the insulating plate 340 is interposed. The electrode terminal 330 is a negative terminal whose polarity is reverse to the polarity of the cap plate 310.

The positive electrode tab 416 withdrawn from the positive electrode 413 is welded to the rear surface of the cap plate 310. The negative electrode tab 417 withdrawn from the negative electrode 415 is welded to the lower end of the electrode terminal 330 and the negative electrode tab 417 is folded in zigzags.

On the other hand, an insulating case 390 is provided on the front surface of the electrode assembly 412 in order to electrically insulate the electrode assembly 412 and the cap assembly from each other and to cover the upper end of the electrode assembly 412 at the same time. The insulating case 390 is formed of an insulating polymer resin and is preferably formed of polypropylene. A negative electrode tab hole 391 is formed on one side of the insulating case 390 so that the negative electrode tab 417 can pass through from the electrode assembly 412. A positive electrode tab hole 392 is formed at the edge on the other side, that is, in the position corresponding to the positive electrode tab 416. An electrolyte through hole 393 may or may not be additionally formed.

An electrolyte injection hole 312 is formed on one side of the cap plate 310. A cap (not shown) for sealing the electrolyte injection hole 312 after an electrolyte has been injected is provided in the electrolyte injection hole 312. The cap is formed by placing a ball shaped mother material commonly formed of aluminum or a metal containing aluminum on the electrolyte injection hole to mechanically press fitting the mother material into the electrolyte injection hole. Therefore, the ball must have a diameter larger than the diameter of the electrolyte injection hole 312.

The cap assembly and the electrode assembly accommodated within the can 411 that have the above-described structures are insulated from each other by the insulating case 390.

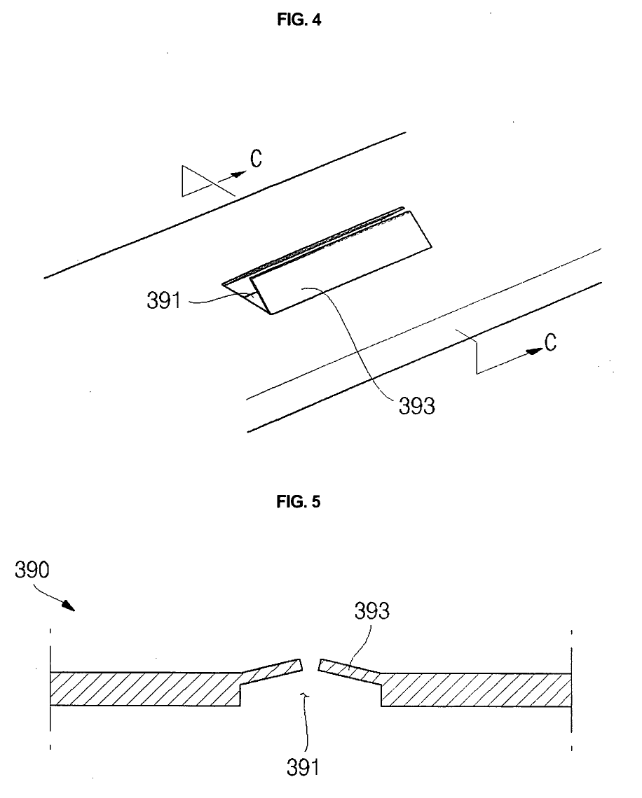

The structure of the negative electrode tab hole 391 of the insulating case 390 is described below in detail with reference to FIGS. 4 and 5.

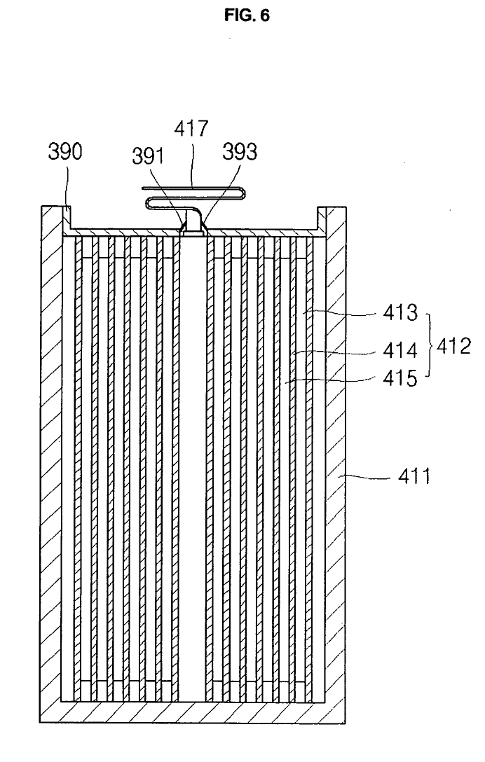

FIG. 4 is a perspective view of an enlarged ‘P’ part in the secondary battery of FIG. 3. FIG. 5 is a side sectional view of barrier ribs taken along the line C-C of the insulating case of FIG. 4. FIG. 6 is a side sectional view taken along the line B-B of FIG. 3 of the insulating case and the electrode assembly that are attached to each other.

As illustrated in FIGS. 4 and 5, the insulating case 390 of the secondary battery according to an embodiment of the present invention further includes barrier ribs 393 extended from both side walls of the negative electrode tab hole 391. The both side walls of the negative electrode tab hole 391 from which the barrier ribs 393 are extended are side walls in a hole that runs parallel to the lengthwise direction of the insulating case.

The barrier ribs 393 have a predetermined slope upward from the insulating case 390. This is for easily inserting the negative electrode tab 417 into the insulating case 390 from the front surface of the insulating case 390 from which the negative electrode tab 417 is withdrawn.

Since the barrier ribs 393 are extended from the both side walls of the negative electrode tab hole 391, the space between the barrier ribs 393 is small so that the negative electrode tab 417 cannot easily pass through the barrier ribs 393 of the negative electrode tab hole 391. Therefore, the barrier ribs 393 are formed to a thickness of 0.1 to 0.2 mm, which is smaller than the thickness of the insulating case 390 so that the negative electrode tab 417 can be easily withdrawn upward from the insulating case 390. This is because, in the case where a force is applied to the barrier ribs 393 when the negative electrode tab 417 is inserted into the thin barrier ribs 393, the barrier ribs 393 are pushed upward so that a space through which the negative electrode tab 417 can pass through can be secured. Therefore, the negative electrode tab 417 can easily pass through the barrier ribs 393 of the negative electrode tab hole 391. The barrier ribs 393 can be formed to be integrated with the insulating case 390 of the insulating polymer resin, for example, the polypropylene like the insulating case 390.

As illustrated in FIG. 6, the barrier ribs 393 having the slope hold and fix the negative electrode tab 417 that passes through the lower part of the negative electrode tab hole 391 and the barrier ribs 393 and that is provided in zigzags on the insulating case 390. Therefore, when an external force is applied to the secondary battery including the insulating case 390 having the barrier ribs 393, the barrier ribs 393 prevent the negative electrode tab 417 formed in zigzags on the insulating case 390 from being pushed toward the lower part of the insulating case 390. Also, when the negative electrode tab 417 formed in zigzags in a predetermined part is pushed toward the electrode assembly 412 to some extent, the barrier ribs 393 prevent the negative electrode tab 417 and the front surface of the electrode assembly 412 from being directly connected to each other. Therefore, the negative electrode tab 417 is not connected to the electrode assembly 412 positioned under the insulating case 390 so that it is possible to prevent the positive and negative electrodes from being shorted.

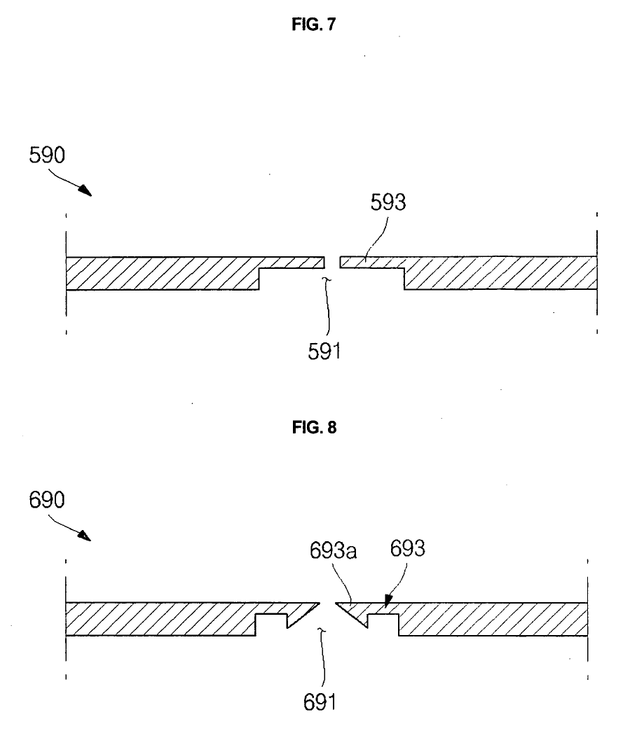

FIG. 7 is a side sectional view of barrier ribs of an insulating case according to another embodiment of the present invention.

The barrier ribs 593 of an insulating case 590 according to another embodiment of the present invention is different from the barrier ribs 393 of the insulating case 390 of FIG. 5 in that the barrier ribs 593 do not have a slope and function the same as the barrier ribs 393 of the insulating case 390.

As illustrated in FIG. 7, the barrier ribs 593 of the insulating case 590 according to another embodiment of the present invention run parallel to the front surface of the insulating case 590 and are extended from the both side walls of a negative electrode tab hole 591. The thickness of the barrier ribs 593 is 0.1 to 0.2 mm, which is small, like the thickness of the barrier ribs 393 of the insulating case 390 of FIG. 5. Therefore, when a force is applied to the barrier ribs 393 when the negative electrode tab 417 illustrated in FIG. 3 is inserted into the barrier ribs 593, the barrier ribs 593 are pushed upward so that a space through which the negative electrode tab 417 can pass can be secured. As a result, the negative electrode tab 417 can easily pass through the barrier ribs 593 of the negative electrode tab hole 591. The barrier ribs 593 hold and fix the negative electrode tab 417 while the negative electrode tab 417 remaining pushed upward after passing through the small space between the barrier ribs 593. The barrier ribs 593 can be formed to be integrated with the insulating case 590 of the insulating polymer resin, for example, the polypropylene like the insulating case 590.

FIG. 8 is a side sectional view of barrier ribs of an insulating case according to still another embodiment of the present invention.

The barrier ribs 693 of an insulating case 690 according to still another embodiment of the present invention function the same as the barrier ribs 593 of the insulating case 590 of FIG. 7. However, the shape of the barrier ribs 693 is different from the shape of the barrier ribs 593.

As illustrated in FIG. 8, the barrier ribs 693 of the insulating case 690 according to still another embodiment of the present invention are extended from the both side walls of a negative electrode tab hole 691 and include tapered parts 693a whose thickness is reduced toward the center of the negative electrode tab hole 691 in the extended ends thereof.

In the barrier ribs 693, the parts excluding the tapered parts 693a are formed to a thickness of 0.1 to 0.2 mm, which is smaller than the thickness of the thickness of the insulating case 690 so that, when a force is applied to the barrier ribs 393 when the negative electrode tab 417 of FIG. 3 is inserted into the barrier ribs 693, the barrier ribs 693 are pushed upward so that the negative electrode tab 417 can easily pass through the space between the barrier ribs 693. The barrier ribs 693 hold and fix the negative electrode tab 417 while the negative electrode tab 417 remaining pushed upward after passing through the small space between the barrier ribs 693.

The tapered parts 693a are reduced from the ends extended from the both side walls of the negative electrode tab hole 691 toward the center of the negative electrode tab hole 691 so that the internal surfaces thereof have a slope in the same direction as the barrier ribs 393 of FIG. 5. The internal surfaces of the tapered parts 693a having such a slope hold and fix the negative electrode tab 417 of FIG. 3 that passes through the negative electrode tab hole 691 and the barrier ribs 693 and that is provided in zigzags on the insulating case 390. The starting parts of the tapered parts positioned in the ends extended from the side wall of the negative electrode tab hole 691 can be formed to be thicker than the barrier ribs 693. Therefore, parts of the tapered parts 693a that hold the negative electrode tab 410 are thicker than the other parts of the barrier ribs 693 to firmly hold the negative electrode tab 417.

The barrier ribs 693 can be formed to be integrated with the insulating case 690 of the same insulating polymer resin, for example, the polypropylene like the insulating case 690.

As described above, in the secondary battery according to an embodiment of the present invention, the barrier ribs extended from the internal wall of the electrode tab hole of the insulating case inserted between the electrode assembly and the cap assembly are formed to fix the electrode tab that passes through the electrode tab hole so that it is possible to prevent the electrode tab folded in zigzags on the insulating case from being bent downward from the insulating case by an external force. Also, when the electrode tab formed in zigzags in a predetermined part is pushed toward the electrode assembly to some extend, the barrier ribs prevent the electrode tab and the front surface of the electrode assembly from being directly connected to each other. Therefore, the electrode tab is not connected to the electrode assembly positioned under the insulating case so that it is possible to prevent the positive and negative electrodes from being shorted. Therefore, it is possible to secure the stability of the secondary battery.

Although exemplary embodiments of the present invention have been described for illustrative purposes, those skilled in the art will appreciate that various modifications, additions and substitutions are possible, without departing from the scope and spirit of the present invention as defined by the accompanying claims.

What is claimed is:

1. A secondary battery comprising:
an electrode assembly including a positive electrode, a negative electrode, a separator interposed between the positive electrode and the negative electrode, and electrode tabs respectively extending from the positive electrode and the negative electrode;
a can for accommodating the electrode assembly;
a cap assembly attached to an opening of the can and connected to the electrode tabs; and
an insulating case arranged between the electrode assembly and the cap assembly and including a hole through which one of the electrode tabs passes, the insulating case including barrier ribs respectively extending from at least portions of side walls of the hole.

2. The secondary battery as claimed in claim 1, wherein at least portions of side walls of the hole are an internal side wall of the hole running parallel to a lengthwise direction of the insulating case.

3. The secondary battery as claimed in claim 1, wherein the electrode tab that passes through the hole is folded in zigzags between the cap assembly and the insulating case and electrically connects an electrode terminal of the cap assembly to one electrode of the electrode assembly.

4. The secondary battery as claimed in claim 2, wherein the barrier ribs are inclined upward away from the insulating case.

5. The secondary battery as claimed in claim 2, wherein the barrier ribs run parallel to a front surface of the insulating case.

6. The secondary battery as claimed in claim 2, wherein the barrier ribs comprise tapered ribs whose thickness is reduced toward a center of the hole from the respective hole side wall.

7. The secondary battery as claimed in claim 6, wherein the starting points of the tapered ribs positioned in ends extending from the respective hole side wall are thicker than the barrier ribs.

8. The secondary battery as claimed in claim 1, wherein the barrier ribs are of a thickness in a range of 0.1 to 0.2 mm.

9. The secondary battery as claimed in claim 1, wherein the barrier ribs are integral with the insulating case and are of the same material.
